(19) United States
(12) Patent Application Publication
(10) Pub. No.: US 2014/0017031 A1
(43) Pub. Date: Jan. 16, 2014

(54) ATTACH TOGGLE

(71) Applicant: The Sloan Company, Inc. dba SloanLED, Ventura, CA (US)

(72) Inventors: Aaron Prichard, Ojai, CA (US); Matthew Heim, Ventura, CA (US)

(73) Assignee: The Sloan Company, Inc. dba SloanLED, Ventura, CA (US)

(21) Appl. No.: 13/730,697

(22) Filed: Dec. 28, 2012

Related U.S. Application Data
(60) Provisional application No. 61/583,057, filed on Jan. 4, 2012.

(51) Int. Cl. F16B 39/282

(52) U.S. Cl. CPC F16B 39/282
USPC 411/204

(57) ABSTRACT

An attachment device comprising a bolt, a toggle adapted to receive the bolt and a nut, wherein the nut is received by the toggle and adapted to exert a force on the toggle in order to mount an external device to a pole or similar structure. The toggle is configured such that gravitational force properly aligns the toggle during installation. The bolt, toggle and nut are arranged to form a structural connection that supports the load of the mounted device as well as external and/or environmental forces which may be exerted upon the structural connection.

This application claims the benefit of priority of Provisional Application Ser. No. 61/583,057 to Aaron Prichard et al., filed on Jan. 4, 2012. Provisional application 61/583,057 including the drawings, schematics, diagrams and written description are hereby incorporated in their entirety by reference.

### BACKGROUND OF THE INVENTION

1. Field of the Invention

This invention relates to an attachment device that allows for a structural connection to a pole or structure where internal access to the pole or structure is limited or not available.

2. Description of the Related Art

A fastener is an attachment device that mechanically joins or affixes two or more objects together. Typical fasteners used to mount an item to a wall are nails or screws. However, using nails or screws in a wall may not provide the structural support necessary to hold the weight of the item being mounted to the wall. In such instances, wall anchors can be used so that the weight of the item is properly distributed to the wall. Wall anchors are fasteners, just like a screw or nail but have a special purpose that helps attach objects to hollow surfaces like walls, ceilings or doors and extremely hard surfaces like concrete, block or brick.

Some typical wall anchors are plastic wall anchors, self tapping screw anchors, expandable metal anchors, and toggle bolts. Plastic wall anchors are inserted into a pilot hole and have an opening to receive a threaded screw or nail such that when the threaded screw or nail is inserted into the plastic wall anchor, the sides of the wall anchor expand and exert a compression force on the interior walls of the pilot hole which resists the applied loads. The plastic wall anchor is typically used for light weight items, such as a picture frame, and is not intended to be used with heavier items or for overhead applications. Self tapping screw anchors have oversized threads that achieve a high holding power and are designed to be screwed into a wall so that it is firmly seated in the wall. Other configurations of self tapping screw anchors can also have wings, such that when a screw is screwed into the self tapping screw anchor the wings open and seat the anchor into the wall.

Expandable metal anchors and toggle bolts are different than plastic wall anchors and self tapping screw anchors in that the expandable metal anchors and toggle bolts are designed to apply a force onto the back surface of a hollow wall in order to provide the necessary structural support. Tension loads are sustained by spreading the load over a bearing surface in the hollow walls while shear load is resisted by the friction developed between the expandable metal anchor or toggle bolt and the wall. Expandable metal anchors have expanded metal straps that are designed to buckle in a specific manner when a screw is screwed in the expandable metal anchor. The buckled metal straps contact the backside of the wall and exert a force on the backside of the wall. Toggle bolts have spring-loaded wings that open up when the toggle bolt is inserted into the wall. The toggle bolt is then pulled backward so that the opened wings are in constant contact with the backside of the wall while the bolt is tightened. Once fully tightened, the opened wings exert a force on the backside of the wall.

Plastic wall anchors, self tapping screw anchors, expandable metal anchors, and toggle bolts all provide varying ranges of structural support, but are intended to be used in residential or commercial settings, such as hollow drywall, gypsum board, solid walls, and masonry walls. Also, these anchors are not necessarily intended to be used in an external setting, such as being used to mount an item to a pole, where environmental weather conditions or other external factors need to be accounted for to ensure that the proper structural support is provided.

### SUMMARY

The invention disclosed herein provides various embodiments of attachment devices that are cost effective, easy to install and provide the required structural support for mounting a device to a pole or similar structure. The different embodiments comprise elements to mount the device to the pole where internal access to the interior of the pole is limited or not available. The mounting elements can comprise many different materials or devices arranged in different ways, with some attachment devices comprising a toggle to mount a device to the pole or similar structure.

In one embodiment, as broadly described herein, an attachment device comprises a bolt including a head and a threaded end opposite the head, a toggle adapted to receive the bolt and a nut, wherein the nut is received by the toggle and adapted to exert a force on the toggle in order to mount an external device to a pole or similar structure. The bolt, toggle and nut form a structural connection that supports the load of the mounted device as well as external and/or environmental forces which may be exerted upon the structural connection.

In another embodiment, an attachment device comprises a bolt including a head and a threaded end, a mounting device including a planar surface and a nut, wherein the mounting device is configured such that the force of gravity exerts a force on the mounting device which properly positions the planar surface such that the planar surface is adapted to contact an internal surface of a pole or similar structure in response to a force exerted by the nut onto the mounting device. The bolt, attachment device and nut form a structural connection to mount an external device to the pole or similar structure that supports the load of the external device as well as external and/or environmental forces exerted on the external device and/or the attachment device.

These and other aspects and advantages of the invention will become apparent from the following detailed description and the accompanying drawings which illustrate by way of example the features of the invention.

### BRIEF DESCRIPTION OF THE DRAWINGS

FIG. 1a is a perspective view of one embodiment of an attachment device according to the invention.

FIG. 1b is a perspective view of the attachment device shown in FIG. 1a.

FIG. 1c is another perspective view of the attachment device shown in FIG. 1a.

FIG. 2a is a perspective view of an installed attachment device.

FIG. 2b is a side view of the installed attachment device shown in FIG. 2a.

### DETAILED DESCRIPTION

The invention described herein is directed to different embodiments of attachment devices that in some embodiments provide mounting elements to mount one element to another element. The mounting elements can comprise many different materials and can be used in many different settings to mount one element to another element such as, but not limited to, a light fixture mounted to a pole. The attachment devices according to the present invention can be arranged in many different ways with many different components, and are generally arranged to provide an improved attachment device that can be easily installed when access to the interior of the pole or similar structure is limited or not available.

In some embodiments, the mounting elements can comprise a bolt including a head and a threaded end opposite the head, a toggle including a longitudinal opening to receive the bolt and a pivot opening substantially perpendicular to the longitudinal opening forming a pivot such that the toggle is adapted to pivot about the pivot opening. The pivot opening is offset from the center of mass of the toggle. The mounting elements further comprise a nut, wherein the nut is received by the toggle and adapted to exert a force on the toggle such that the toggle forms a structural connection with an interior surface of a pole in order to mount an element to an exterior surface of the pole. This arrangement allows for the attachment device to be installed in the pole by way of a small hole in the pole. An advantage of the attachment device is that the small hole used to install the attachment device does not negatively impact the structural integrity of the pole. The bolt, toggle and nut form a structural connection that supports the load of the mounted element as well as any external and/or environmental forces which may be exerted upon the structural connection and/or the mounted element.

Toggle bolts are generally known in the art and are typically used to mount an item to hollow base walls. They come in different sizes and can comprise a threaded bolt with a spring-loaded toggle. The spring-loaded toggle has a wing-like element comprised of two wings joined together at a pivot point and a spring that opens up the two wings about the pivot point. When inserted into the hollow wall the wing-like element is configured to contact the backside surface of the hollow wall. Other toggle bolts have a longitudinal element that is inserted into the hollow wall and requires a user to manually rotate the longitudinal element about a pivot located at the center of the longitudinal element in order for the longitudinal element to contact the back surface of the wall. A threaded bolt can then be screwed into a threaded hole located at the central pivot of the longitudinal element in order to cause the longitudinal element to apply a force on the backside surface of the hollow wall.

Conventional toggle bolts are normally used to mount pictures, shelves, and other items on a wall in a residential or commercial setting, but do not provide the necessary structural support for mounting items that are heavier which can be subjected to forces of nature such as, wind, hail or earthquakes. Furthermore, these conventional toggle bolts can be comprised of cumbersome elements that further complicate or reduce the ease of the installation of these toggle bolts. For example, in spring-loaded toggle bolts the size of the hole in the wall is determined by the size of the wing-like element, which is normally bigger than the size of the nut and threaded bolt. In some spring-loaded toggle bolts, the two wings of wing-like element, when fully deployed about a pivot point, are slightly angled and do not provide a flat surface to contact the back surface of the wall. In such instances only a portion of the two wings, normally the end points, are able to contact the back surface of the wall. As such, the load is distributed to the end points of the wing-like element which can cause the end points to dig in or pierce the back surface of the wall and possibly compromise the structural integrity of the wall and/or the load bearing properties of the toggle bolt.

Other conventional toggle bolts have wing-like elements that are configured so that the two wings, when fully deployed about a pivot point, can form a substantially continuous surface and are not slightly angled. This allows the length of the wing-like element between the two end points of the wings to contact the back surface of the wall. However, in both of the conventional spring-loaded toggle bolts, discussed above, each of the two wings must be shaped to compensate for the threaded bolt and the other wing when the wings are folded at the pivot point and onto the threaded bolt. The size of the spring-loaded toggle bolt when the wings are folded onto the treaded bolt determines the size of the hole in the wall required to install the spring-loaded toggle bolt. In order to install the conventional spring-loaded toggle bolt, the wings are folded at the pivot point and onto the threaded bolt; thereby allowing the spring-loaded toggle bolt to be inserted into the hole in the wall. The two wings of the wing-like elements are typically U-shaped such that the wings have ridges that extend away from a base. When the spring-loaded toggle bolt is inserted into the hole in the wall, the spring causes the wings to deploy and contact the backside surface of the wall. However, when installed, only the ridges of the wings are able to contact the backside surface of the wall. As such, the load is distributed along the ridges of the wings which could cause the ridges to pierce the back surface of the wall. The wing-like element of conventional spring-loaded toggle bolts does not provide a planar surface that contacts the backside surface of the wall so as to evenly distribute the load.

The attachment device of the present invention can provide a number of additional advantages beyond those mentioned above. For example, the toggle is arranged to provide a substantially planar surface. This allows the toggle to evenly distribute the load along the substantially planar surface when installed. Additionally, the pivot opening being offset from the center of mass of the toggle allows the toggle to be deployed under the influence of gravity. The weight of opposing portions of the toggle about the pivot opening is different, such that one portion weighs more than the opposing second portion. The toggle is arranged such that gravity pulls on the heavier portion causing the toggle to pivot about the pivot opening and properly aligning the toggle for installation. In many instances, internal access of the pole is not available and a user is not able to visually verify that the toggle is properly aligned. The force of gravity assists in properly aligning the toggle in the pole or similar surface, thereby substantially reducing installation errors. Additionally, the toggle is adapted to receive the nut such that the toggle prevents the nut from rotating when received by the toggle. This arrangement assists in maintaining the structural connection provided by the bolt, toggle and nut so that the attachment device does not lose strength over time.

Some embodiments of attachment devices according to the invention can be used to mount light fixtures to a pole, such as those used to provide light in a parking lot, tennis courts or the like. However, the invention is not intended to be limited to such embodiments. As further described below, the attachment devices can be arranged to allow a single individual to easily install the attachment device in order to mount a light fixture to a pole.

The invention is described herein with reference to certain embodiments, but it is understood that the invention can be embodied in many different forms and should not be construed as limited to the embodiments set forth herein. In particular, the present invention is described below in regards to certain lighting fixtures in different configurations, but it is understood that the invention can be used for many other devices having many different configurations. The components can have different shapes and sizes beyond those shown in the figures or discussed herein.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the device in addition to the orientation depicted in the figures.

Although the terms first, second, etc. may be used herein to describe various elements or components, these elements or components should not be limited by these terms. These terms are only used to distinguish one element or component from another. Thus, a first element discussed herein could be termed a second element without departing from the teachings of the present application. It is understood that actual systems or fixtures embodying the invention can be arranged in many different ways with many more features and elements beyond what is shown in the figures.

Embodiments of the invention are described herein with reference to illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the invention.

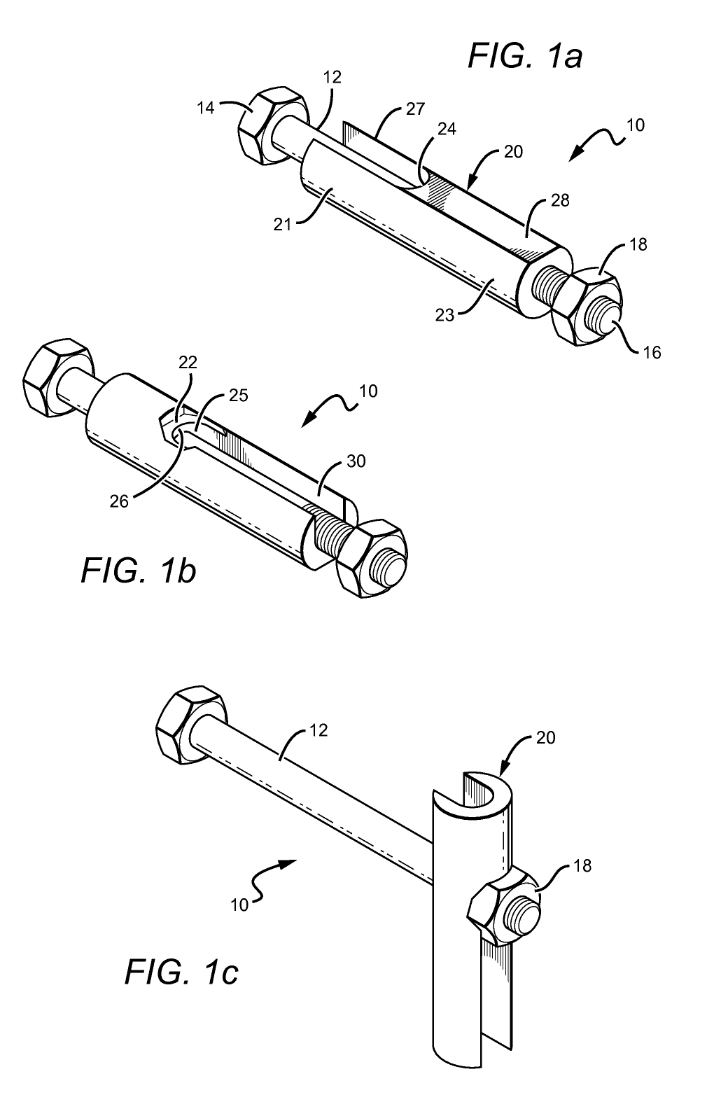

With reference to FIGS. 1a-1c, an exemplary attachment device 10 is shown. In some embodiments the attachment device is configured such that the attachment device 10 can be installed in a pole, wall, or similar structure to form a structural connection in order to mount a device to the pole, wall, or similar structure. The attachment device 10 comprises a bolt 12, a toggle 20 and a nut 18, wherein the bolt includes a head 14 and a threaded end 16 opposite the head 14. The toggle comprises a longitudinal opening 30 that receives the bolt 12. The toggle 20 further comprises a first channel 24 that extends into the toggle 20 towards the longitudinal opening 30 and a second channel 26 opposite the first channel 24 that also extends into the toggle 20 towards the longitudinal opening 30. The nut 18 is threadedly received by the threaded end 16 of the bolt 12 and is adapted to exert a force on the toggle 20. When the attachment device 10 is inserted into the pole or similar structure, the force exerted by the nut 18 onto the toggle 20 causes the toggle 20 to contact a backside or interior surface of the pole or similar structure, thereby securing the toggle 20 to the backside or interior surface and allowing a device to be mounted onto an exterior surface of the pole or similar structure.

The toggle 20 comprises a pivot opening 25 that is substantially perpendicular to the longitudinal opening 30 and is located offset from the center of mass of the toggle 20. The toggle 20 further comprises a first portion 21 and a second portion 23 opposite the first portion, wherein the first and second portions are joined at the pivot opening 25. The first channel 24 exposes a portion of the longitudinal opening 30 from the pivot opening 25 to the end of the first portion 21. The second channel 26 exposes a portion of the longitudinal opening from the pivot opening 25 to the end of the second portion 23. The first and second channels 24, 26 are on opposing sides of the toggle 20 and are also aligned about the pivot opening. The exposed portions of the longitudinal opening 30 allow the toggle 20 to pivot on the bolt 12 about the pivot opening 25. The first and second channels 24, 26 are arranged to provide a passage to allow the toggle 20 to pivot on the bolt 12 in response to gravitational forces. The first and second channels 24, 26 compensate for the dimensions of bolt 12, such that the bolt 12 and/or the first and second channels 24, 26 do not impede or hinder the toggle's pivoting motion. The toggle's pivoting motion comes to a rest when the toggle 20 is substantially perpendicular to the bolt 12. After the toggle 20 has completed the pivoting motion, the bolt 12 is substantially aligned with the pivot opening 25 and the first portion 21 of the toggle 20 is on the bolt 12, as shown in FIG. 1c.

In the embodiment shown in FIGS. 1a-1c, the length of the first portion 21 is less than the length of the second portion 23 due in part to the pivot opening 25 being offset from the center of mass of the toggle 20. This configuration results in the second portion 23 weighing more than the first portion 21. Gravity pulls on the heavier second portion 23 which causes the toggle 20 to pivot on the bolt 12 about the pivot opening 25, such that the toggle 20 is deployed under the influence of gravity, as shown in FIG. 1c. When the toggle 20 is deployed, the lighter first portion 21 is on the bolt 12 and the heavier second portion 23 is under the bolt.

The toggle 20 in FIGS. 1a-1c is depicted as having a substantially cylindrical-like shape wherein the weight and length of the first and second portions 21, 23 about a central point of the toggle 20, which in this instance coincides with the center of mass of the toggle 20, is substantially similar. However, in other embodiments the central point of the toggle 20 does not necessarily coincide with the center of mass of the toggle 20. In one example of such an arrangement, the toggle can be configured such that the portion of the toggle having a shorter length can weigh more than the other longer portion, wherein gravity acts on the heavier shorter portion of the toggle to cause the toggle to pivot about the pivot opening. In yet another example, the pivot opening can be at the central point of the toggle so that the length of the first and second portions are substantially the same, but the center of mass of the toggle is not located at the central point of the toggle such that one of the portions is heavier than the other portion. Gravity will pull on the heavier portion of the toggle causing the toggle to pivot about the pivot opening. The toggle 20 can be arranged in many different configurations and is not intended to be limited to the embodiments discussed herein.

The pivot opening 25 being offset from the center of mass of toggle 20 allows the attachment device 10 to take advantage of gravitational forces to properly position the toggle 20 during installation of the attachment device in the pole or similar structure. An advantage of the invention is that gravity acting on the toggle 20 eliminates the need for cumbersome or additional elements to properly align the toggle, such as a spring, wing-like elements and the like. Yet another advantage is that the configuration of the invention reduces installation errors as well as manufacturing costs. It is important that the toggle 20 be properly aligned because proper alignment provides the requisite structural connection that can withstand the load from the mounted device and any external and/or environmental forces. Additionally, the second portion 23 of the toggle 20 comprises a planar surface 28 opposite the second channel 26 and proximate the first channel 24. The planar surface 28 is arranged to contact the backside surface of the pole to form the structural connection. An advantage of the invention is that the toggle 20 allows the load to be evenly distributed on the planar surface 28, which in turn provides a greater continuous load bearing surface area in comparison to conventional toggle bolts.

Conventional toggle bolts, as discussed above, provide a reduced load bearing surface area such as ridges or end points that contact the backside or interior surface of a wall. While other typical toggle bolts provide a non-continuous load bearing surface formed by wing-like elements pivoting about a pivot point. Thus, the attachment device 10 can withstand loads greater than conventional toggle bolts. In some embodiments, the attachment device 10 can withstand tension loads of up to 4,000 pounds and/or shear force of up to 2,000 pounds. These values are examples of the loads and/or force the attachment device 10 can withstand and the invention is not intended to be limited to the examples provided herein. Other embodiments can be configured to withstand higher or lower tension loads and shear force.

As shown in FIG. 1b, the toggle 20 further comprises a slotted hole 22 axially aligned with the pivot opening 25. The slotted hole is adapted to receive the nut 18 after the toggle has been deployed. For the same or similar elements or features, the reference numbers from FIGS. 1a-1c will be used throughout the application herein. The slotted hole 22 can be shaped similar to the nut 18, such that the slotted hole 22 prevents the nut 18 from rotating after the nut 18 has been received by the slotted hole 22. The slotted hole 22 holds the nut 18 stationary in place and allows the bolt 12 to be turned so that the nut 18 can be further threadedly received on the bolt 12. Turning or screwing the bolt 12 causes the nut 18 to exert a force onto the toggle 20, such that the toggle 20 contacts and exerts a force on the interior surface or backside wall of the pole or mounting structure. Increasingly screwing the bolt 12 so that the nut 18 is further threadedly received, increases the force the nut 18 exerts on the toggle 20, which increases the force the toggle 20 exerts on the interior surface of the pole. The planar surface 28 of the toggle 20 contacts the interior surface of the pole, and allows the force exerted on the pole by the toggle 20 to be evenly distributed. The bolt 12, toggle 20 and nut 18, when sufficiently tightened form the structural connection so that a device can be mounted onto the pole. The slotted hole 22 assists in maintaining the structural connection so as to ensure that the attachment device 10 does not fail. In some embodiments, the nut 18 is a hex nut and the slotted hole 22 is similarly shaped. However, the nut 18 and slotted hole 22 can have many different shapes and are not limited to any particular shape. In other embodiments, the slotted hole 22 can be shaped differently than the nut 18, but still be configured to receive the nut 18 and prevent the nut 18 from rotating.

Referring to FIGS. 1a and 1b, the first channel 24 of the toggle 20 extends along the first portion 21 of the toggle 20 and ends at the pivot opening 25. The second channel 26 is opposite the first channel 24 and extends along the second portion 23 and also ends at the pivot opening 25. The first and second channels 24, 26 allow the toggle 20 to pivot about the pivot opening 25 in response to gravitational forces. The first portion 21 comprises planar ridges 27 adjacent the first channel 24 and proximate the planar surface 28 of the second portion 23. The toggle 20 is configured such that the planar ridges 27 and the planar surface 28 are both aligned along the same plane in order to form a continuous planar surface. This configuration allows for the planar ridges 27 and the planar surface 28 to both contact the backside surface of the pole to form the structural connection, such that the load is distributed along the planar ridges 27 and the planar surface 28, and not only distributed on planar surface 28. At least one advantage of the planar ridges 27 and planar surface 28 being aligned on the same plane is that the load will not cause the planar ridges 27 to pierce or dig into the backside surface of the pole, which could compromise the structural connection or the load bearing properties of the attachment device 10. Yet another advantage of the invention is that the planar ridges 27 and planar surface provide a continuous load bearing surface area along the length of the toggle 20.

The bolt 12, toggle 20 and nut 18 can be made of many different materials. In one embodiment, the bolt 12 can be a grade 8 hex bolt that is fully threaded or partially threaded. In other embodiments, the bolt 12 can be a stainless steel bolt, galvanized steel bolt or any other bolt known in the art. In some embodiments, the toggle 20 can be formed of 4130 alloy steel or any other steel in the 41xx family. In some embodiments, the toggle 20 can be cylindrically shaped, whereas in other embodiments the toggle 20 can shaped differently such as rectangular, triangular or any other shape. However, these are merely examples and are not intended to limit the scope of the invention.

In an embodiment of the invention, the attachment device 10 is used to mount a light fixture to a pole or structure in an outdoor setting such as, a parking lot or tennis court, and is designed to ease the installation of the light fixture such that the light fixture can be installed by a single person. In some embodiments the pole can be a painted pole, a steel pole, galvanized steel pole, an anodized aluminum pole or any other type of pole known in the art.

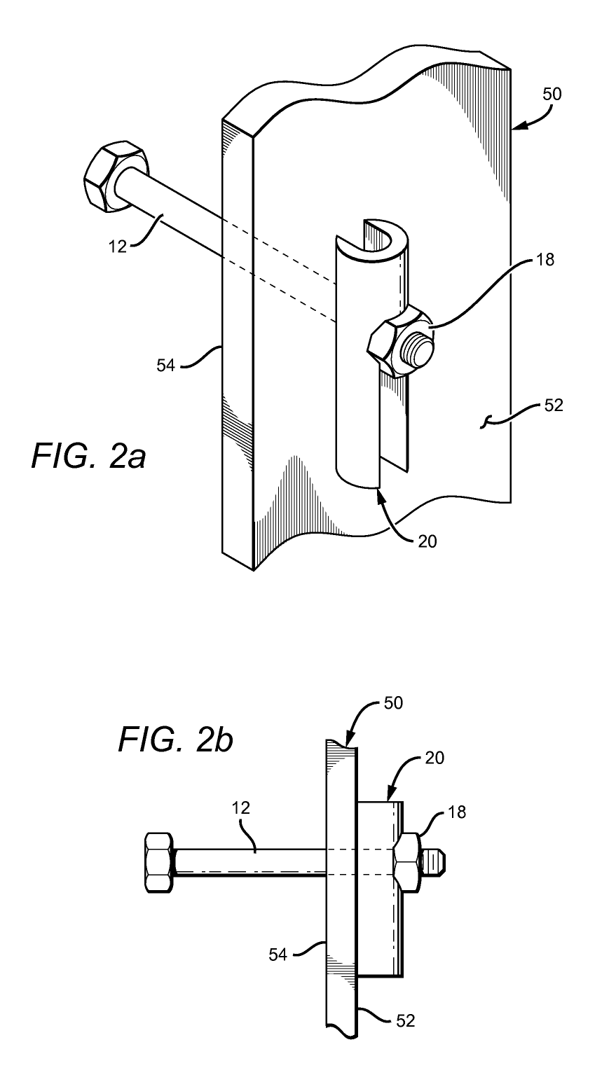

In order to install the attachment device 10 as shown in FIGS. 2a-2b, a hole of sufficient size is needed at the point at which the attachment device 10 is to be installed. The hole is drilled into the structure 50 at the desired installation point, if a hole is not already present. The hole allows the attachment device 10 to be inserted into the structure 50 yet being small enough to not affect the structural integrity of the pole. FIG. 1a shows the first condition of the attachment device 10 prior to and during insertion in the hole. Prior to inserting the attachment device 10 into the hole, the toggle 20 must be arranged on the bolt 12 such that the second portion 23 of the toggle 20 is on the bolt 12, whereby the planar surface 28 is facing up. This allows the toggle 20 to be aligned with the bolt 12 so that the device 10 can be inserted in the hole. Upon insertion, the bolt 12 is turned and is momentarily in a second condition, as shown in FIG. 1b. At this second condition, gravitational forces pull down the second portion 23 causing the toggle 20 to pivot on the bolt 12 about the pivot opening 25 which properly aligns the toggle 20 so that the planar surface 28 and ridges 27 are facing and arranged to contact the backside/interior surface of the structure 50. FIGS. 1c, 2a and 2b show the third condition of the device 10, wherein the toggle 20 is deployed under the influence of gravity. After the toggle 20 is deployed under the influence of gravity, a pulling force is applied to the bolt 12 causing the toggle 20 to contact the backside surface 52 of the structure 50 such that the nut 18 is received in the slotted hole 22 of the toggle 20. With the nut 18 in the slotted hole 22 and the pulling force maintained on the head 14, the bolt 12 can be screwed so that the nut 18 can be further threadedly received on the bolt 12 to form the structural connection and mount the light fixture or other article to an exterior surface 54 of the structure 50. The slotted hole 22 prevents the nut 18 from rotating while the bolt 12 is being screwed and causes the nut to impart a force on the toggle 20 such that the planar surface 28 and ridges 27 contact the backside surface of the pole, thereby securely mounting the light fixture to the pole.

The attachment device 10 is designed to withstand not only the load exerted by the light fixture mounted to the pole or structure, but also environmental and/or external forces that can exert an additional load on the attachment device 10. For example, the device 10 is adapted to withstand wind forces or other natural phenomena that may cause the pole and/or light fixture to vibrate. In another example, the device is adapted to withstand an impact force or shock load due to a hail storm or a tennis ball, basketball, baseball or any other projectile having to do with a sports-related venue. In yet other embodiments, the device 10 can also be used to mount items to a wall in an outdoor setting or in a residential or commercial setting, similar to conventional wall anchors discussed above.

The attachment device according to the invention is designed to be easily installed when internal access to a pole or structure is not available. However, in other embodiments where internal access is available the device can be configured such that a mounting device including a planar surface and a threaded opening is inserted into the pole and positioned within the pole to receive a bolt. The bolt is screwed into the threaded hole of the mounting device which causes the planar surface to contact the backside surface of the pole and forms the structural connection. In some embodiments the mounting device is held in position within the pole using wires or is suspended within the pole using rope, cable, zip ties or the like.

Although the present invention has been described in considerable detail with reference to certain configurations thereof, other versions are possible. For example, in other embodiments the toggle can be shaped to match the interior surface of the mounting structure, yet still have at least one planar surface that contacts the interior surface of the mounting structure. The attachment device according to the invention can be many different sizes, can be formed of different materials, and can be used in many different configurations. Therefore, the spirit and scope of the invention should not be limited to the versions described above.

We claim:

1. An attachment device, comprising:
a bolt including a head and a threaded end;
a toggle including a longitudinal opening and a pivot opening, wherein said longitudinal opening receives said bolt such that said toggle is adapted to pivot about said pivot opening in response to gravitational forces; and
a nut threadedly received by said threaded end, wherein said nut is adapted to exert a force on said toggle as said nut is threaded onto said bolt.

2. The attachment device of claim 1, said toggle further comprising a first portion and a second portion opposite the first portion, wherein said first and second portions are joined at said pivot opening.

3. The attachment device of claim 2, said first portion comprising a first channel and said second portion comprising a second channel.

4. The attachment device of claim 3, wherein said first channel extends into said toggle such that said first channel exposes at least a portion of said longitudinal opening.

5. The attachment device of claim 3, wherein said second channel extends into said toggle such that said second channel exposes at least a portion of said longitudinal opening.

6. The attachment device of claim 3, wherein said first and second channels are arranged to provide a passage such that said toggle can pivot on said bolt about said pivot opening.

7. The attachment device of claim 1, wherein said pivot opening is substantially perpendicular to said longitudinal opening.

8. The attachment device of claim 1, wherein said pivot opening is offset from the center of mass of said toggle.

9. The attachment device of claim 2, wherein said first portion has a length that is less than said second portion.

10. The attachment device of claim 2, wherein said second portion weighs more than said first portion.

11. The attachment device of claim 3, said second portion comprising a substantially planar surface along the length of said second portion opposite said second channel.

12. The attachment device of claim 11, said first portion comprising planar ridges adjacent said first channel and proximate said substantially planar surface, wherein said planar ridges and said substantially planar surface are aligned along the same plane to form a continuous planar surface.

13. The attachment device of claim 1, said toggle further comprising:
a slotted hole adapted to receive said nut; and
a substantially planar surface, wherein said slotted hole is axially aligned with said pivot opening and opposite said substantially planar surface.

14. The attachment device of claim 13, wherein said slotted hole is adapted to prevent said nut from rotating while said nut is received by said slotted hole and said bolt is turned to further threadedly receive said nut.

15. The attachment device of claim 13, wherein said gravitational forces properly aligns said toggle, following insertion of said attachment device into a hole of a structure so that said nut can be received by said slotted hole, whereby rotation of said bolt causes said nut to exert said force onto said toggle such that said substantially planar surface contacts an interior surface of said structure and distributes said force along said substantially planar surface to form a structural connection.

16. The attachment device of claim 15, wherein said structural connection provides support to allow said attachment device to mount a device to an exterior surface of said structure.

17. An attachment device to mount an article to a structure, comprising:
a bolt including a head and a threaded end;
a toggle including a longitudinal opening to receive said bolt, a pivot opening offset from the center of mass of said toggle, and first and second channels on opposite surfaces of said toggle and aligned at said pivot opening; and
a nut threadedly received by said threaded end and adapted to be received by said toggle at said pivot opening, wherein said toggle is adapted to pivot on said bolt about said pivot opening in response to gravitational forces so as to arrange said toggle substantially perpendicular to said bolt.

18. The attachment device to mount an article to a structure of claim 17, said toggle further comprising a substantially planar surface proximate said first channel and opposite said second channel.

19. The attachment device to mount an article to a structure of claim 18, wherein said nut is adapted to exert a force on said toggle such that said substantially planar surface contacts an interior surface of said structure whereby said toggle is secured to said interior surface forming a structural connection so as to mount said article to said structure.

20. The attachment device to mount an article to a structure of claim 17, said first and second channels arranged to expose respective portions of the longitudinal opening to form a passage to allow said toggle to pivot on said bolt about said pivot opening.
